(19) United States
(12) Patent Application Publication
(10) Pub. No.: US 2008/0311349 A1
(43) Pub. Date: Dec. 18, 2008

(54) Metallized Films and Articles Containing the Same

(76) Inventors: Michael A. Johnson, Stillwater, MN (US); Ronald S. Steelman, Woodbury, MN (US); William J. Hunt, Afton, MN (US)

Correspondence Address: 3M INNOVATIVE PROPERTIES COMPANY, PO BOX 33427, ST. PAUL, MN, 55133-3427, US

(21) Appl. No.: 11/909,481

(22) PCT Filed: Mar. 24, 2006
(86) PCT No.: PCT/US06/10786

§ 371 Date: Sep. 24, 2007

Related U.S. Application Data
(60) Provisional application No. 60/664,837, filed on Mar. 24, 2005.

(51) Int. Cl. B32B 7/12; B05D 3/06; B32B 27/32; B32B 27/16; B32B 27/28; B05D 5/10

(52) U.S. Cl. 428/172; 428/353; 428/425.8; 428/461; 428/458; 427/207.1; 427/540; 156/278

(57) ABSTRACT

Metallized films and articles including a metallized film are disclosed. The metallized films may include multiple layers in which a metal layer is positioned between and in contact with two cross-linked polymeric layers.

### FIELD OF THE INVENTION

The present invention relates to metallized films, articles containing the same, and methods of making metallized films and articles containing a metallized film.

### BACKGROUND OF THE INVENTION

Metallized films are widely used to form three-dimensional decorative articles that can be attached to a variety of industrial and consumer items such as motorized vehicles, boats, furniture, building materials, appliances, signs and the like. These decorative or functional articles can be substituted for their metal counterparts resulting in at least one of the following: lighter weight, lower manufacturing costs, better weather resistance, design flexibility, alternative physical or mechanical properties, and sharper detail.

### SUMMARY OF THE INVENTION

The present invention is directed to metallized films and articles that include at least one metallized film. The metallized films comprise a number of individual layers, each of which contributes one or more features to the resulting metallized film or article containing the same. For example, in one embodiment of the present invention, the metallized film comprises (i) a polymeric primer layer comprising a first polymer at least a portion of which is cross-linked; (ii) a polymeric protective layer comprising a second polymer at least a portion of which is cross-linked; (iii) and a metal layer between the polymeric primer layer and the polymeric protective layer.

In a further exemplary embodiment of the present invention, the metallized film comprises a polymeric primer layer comprising a first polymer at least a portion of which is cross-linked; a polymeric protective layer comprising a second polymer at least a portion of which is cross-linked; and a metal layer between the polymeric primer layer and the polymeric protective layer, wherein (i) the polymeric primer layer has an outer adhesive surface opposite the metal layer or (ii) the metallized film further comprises an adhesive layer on the polymeric primer layer opposite the metal layer, the adhesive layer having an outer adhesive surface opposite the polymeric primer layer. The outer adhesive surface of the polymeric primer layer can be tacky at room temperature (e.g., a pressure sensitive adhesive (PSA)) or become tacky when exposed to heat (e.g., a heat-activatable adhesive). In one exemplary embodiment, an outer adhesive surface of the polymeric primer layer is a pressure sensitive adhesive (PSA).

In some embodiments wherein the metallized film further comprises an adhesive layer, the adhesive layer may be a pressure sensitive adhesive (PSA) layer, a heat-activatable adhesive layer (e.g., a hot-melt adhesive layer), or a combination thereof. In other embodiments, the adhesive layer may be a thermosettable adhesive or a thermosettable PSA. When the adhesive layer comprises a pressure sensitive adhesive (PSA) layer, the metallized film may further comprise a release liner to provide temporary protection to an exposed outer surface of the pressure sensitive adhesive layer.

In yet a further exemplary embodiment of the present invention, the metallized film comprises (i) a polymeric primer layer comprising a first polymer at least a portion of which is cross-linked; (ii) a polymeric protective layer comprising a second polymer at least a portion of which is cross-linked; (iii) a metal layer between the polymeric primer layer and the polymeric protective layer; and (iv) a pressure sensitive adhesive (PSA) layer on the polymeric primer layer opposite the metal layer. In this exemplary embodiment, the metallized film may further comprise a release liner to provide temporary protection to an exposed outer surface of the pressure sensitive adhesive (PSA) layer.

The present invention is also directed to articles of manufacture comprising at least one metallized film, such as the exemplary metallized films described above. In addition to (i) a polymeric primer layer comprising a first polymer at least a portion of which is cross-linked; (ii) a polymeric protective layer comprising a second polymer at least a portion of which is cross-linked; (iii) a metal layer between the polymeric primer layer and the polymeric protective layer; and (iv) an adhesive layer on the polymeric primer layer opposite the metal layer, articles of the present invention may comprise one or more additional layers including, but not limited to, additional adhesive layers, one or more release liners, additional polymeric protective layers, additional polymeric primer layers, a thermoformable layer, one or more permanently attached substrates, and combinations thereof. In one exemplary embodiment, the article comprises a metallized film attached to an elastomeric substrate, such as a weatherstrip material. In another exemplary embodiment, the article comprises a metallized film attached to a thermoformable layer to form a thermoformable article that can be thermoformed to form a thermoformed article comprising a metallized film of the present invention.

The present invention is further directed to methods of preparing metallized films, as well as methods of making articles that include at least one metallized film. In an exemplary embodiment, a method of forming a metallized film comprises the steps of providing a polymeric protective layer having an outer surface; depositing a metal layer over the outer surface; applying a polymeric primer layer over the metal layer; cross-linking the polymeric protective layer and the polymeric primer layer; and optionally applying an adhesive layer over the polymeric primer layer, wherein either (i) the polymeric primer layer has an outer adhesive surface opposite the metal layer or (ii) the metallized film comprises the adhesive layer over the polymeric primer layer opposite the metal layer, the adhesive layer having an outer adhesive surface opposite the polymeric primer layer. A variety of film-forming methods, metal deposition methods, coating methods, and/or cross-linking methods may be used in the methods of the present invention. In the methods of making articles including at least one metallized film, the methods may include additional steps such as a thermoforming step

The above summary is not intended to describe each disclosed embodiment or every implementation of the present invention. The detailed description section that follows more particularly exemplifies these embodiments.

### BRIEF DESCRIPTION OF THE DRAWINGS

The above aspects may be more completely understood in consideration of the following detailed description of various embodiments in connection with the accompanying drawings, in which:

FIG. 1 is a cross-sectional view of an exemplary metallized film of the present invention;

FIG. 2A is a perspective view of ah exemplary metal layer suitable for use in an exemplary metallized film of the present invention;

FIG. 2B is a perspective view of another exemplary metal layer suitable for use in an exemplary metallized film of the present invention;

FIG. 2C is a perspective view of an exemplary metal layer suitable for use in an exemplary metallized film of the present invention, wherein the exemplary metal layer comprises a discontinuous pattern having at least two separate metal areas;

FIG. 3A is a perspective view of an upper surface of an exemplary metal area suitable for use in a metal layer of a metallized film of the present invention, wherein the exemplary metal area comprises a visually continuous, but conductively discontinuous metal area;

FIG. 3B is a cross-sectional view of the exemplary metal area of FIG. 3A;

FIG. 4 is a perspective view of the individual layers in the exemplary metallized film of FIG. 1;

FIG. 5 is a cross-sectional view of an exemplary article comprising a metallized film of the present invention;

FIG. 6 is a cross-sectional view of an exemplary article comprising a metallized film adhered to a substrate;

FIG. 7A is a perspective view of an exemplary mold used in a thermoforming step in Examples 7-8 and Reference Example R1;

FIG. 7B is a side view of the exemplary mold shown in FIG. 7A as viewed in the direction of arrow A shown in FIG. 7A; and

FIG. 8 is a graph showing a plot of specularity versus wavelength for film samples of Examples 7-8 and Reference Example R1.

While the invention is amenable to various modifications and alternative forms, specifics thereof have been shown by way of example in the drawings will be described in detail. It should be understood, however, that the intention is not to limit the invention to the particular embodiments described. To the contrary, the intention is to cover all modifications, equivalents, and alternatives falling within the spirit and scope of the present disclosure.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the present invention is intended by the use of specific language. Alterations, further modifications, and such further applications of the principles of the present invention discussed are contemplated as would normally occur to one ordinarily skilled in the art to which the invention pertains.

The present invention is directed to metallized films and methods of making metallized films. The present invention is further directed to articles of manufacture that include at least one metallized film, as well as methods of making articles of manufacture that include at least one metallized film.

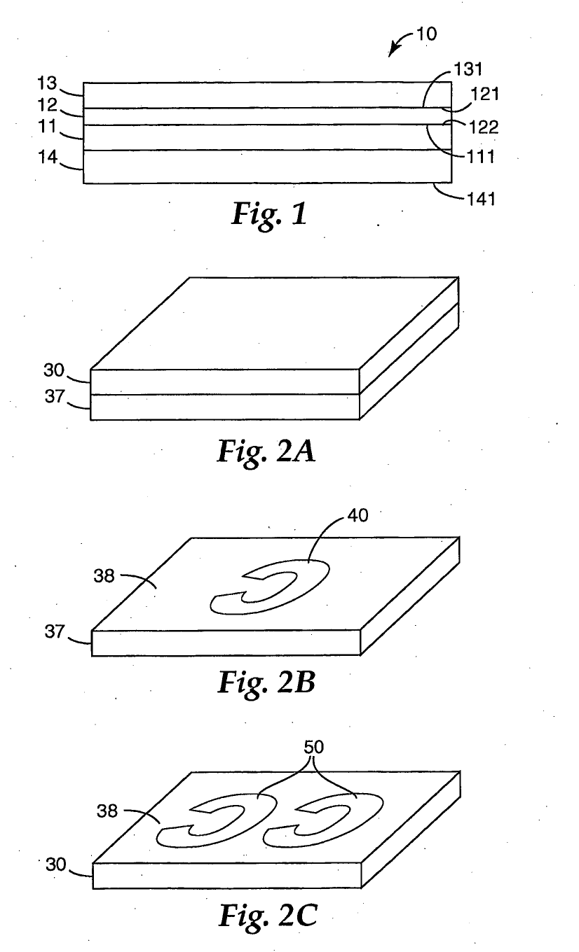

An exemplary metallized film of the present invention is provided in FIG. 1. As shown in FIG. 1, exemplary metallized film 10 comprises at least partially cross-linked polymeric primer layer 11, metal layer 12, at least partially cross-linked polymeric protective layer 13, and adhesive layer 14. In this exemplary embodiment, outer surfaces 121 and 122 of metal layer 12 are in direct contact with cross-linked outer surface 131 of polymeric protective layer 13 and cross-linked outer surface 111 of polymeric primer layer 11 respectively. Further, in this embodiment, adhesive layer 14 is in direct contact with polymeric primer layer 11.

It has been discovered that positioning a metal layer between two at least partially cross-linked layers results in a metallized film having a number of desired properties. In some embodiments, the resulting metallized film has a surprisingly low amount of loss in optical density after stretching. Further, in some embodiments, the resulting metallized film has a surprising increase in surface resistivity after stretching. Isolating and constraining the metal layer between two cross-linked polymeric layers results in a surprisingly significant improvement in the overall performance properties of the resulting metallized film. Specific properties such as, for example, film elasticity, thermal degradation, and corrosion resistance, are improved and result in a metallized film with greater robustness in subsequent processing steps, as well as environmental durability.

As used in the present invention, the term “cross-linked” refers to a polymeric material that exhibits what is in effect a high to nearly infinite molecular weight such that the polymeric material resists flowing when mechanically deformed or exposed to high temperatures. The phrase “at least partially cross-linked” refers to a polymeric material or layer of polymeric material, at least a portion of which resists flowing when mechanically deformed or exposed to high temperatures. For example, a relatively thick layer of polymeric material may be at least partially cross-linked such that a first outer surface resists flowing when mechanical deformed or exposed to high temperatures, while an opposite second outer surface exhibits minimal flow resistance when mechanical deformed or exposed to high temperatures.

As illustrated in FIG. 1, metallized films of the present invention may comprise a number of individual layers. A description of individual layers, the overall construction, and various film construction parameters of exemplary metallized films of the present invention is provided below.

### I. Metallized Film Construction and Properties

The metallized films of the present invention have a unique film structure. A description of each layer of the metallized films of the present invention, as well as exemplary film properties of the resulting metallized film is provided below.

A. Metallized Film Layers

The metallized films of the present invention comprise one or more of the following individual layers.

1. Polymeric Protective Layer

The metallized films of the present invention comprise at least one polymeric protective layer, such as exemplary polymeric protective layer 13 of exemplary metallized film 10. The polymeric protective layer covers an adjacent metal layer, providing one or more of the following properties to the resulting metallized film: scratch resistance, impact resistance, water resistance, weather resistance, solvent resistance, resistance to oxidation, and resistance to degradation by ultraviolet radiation. In most embodiments, the polymeric protective layer completely covers the adjacent metal layer such that no portion of the metal layer is exposed.

The polymeric protective layer may comprise one or more polymeric components, wherein at least one of the one or more polymeric components is cross-linked. In some embodiments of the present invention, only an outer surface of the polymeric protective layer adjacent the metal layer is cross-linked. In other embodiments of the present invention, cross-linked polymeric material is essentially distributed throughout an entire thickness of the polymeric protective layer (i.e., the entire polymeric protective layer is subjected to a cross-linking step as opposed to just an outer surface of the polymeric protective layer).

In other embodiments of the present invention, the degree of cross-linking within the polymeric protective layer varies to form a cross-linking gradient along a thickness of the polymeric protective layer, wherein an outer surface of the polymeric protective layer adjacent the metal layer has a relatively high degree of cross-linking, and the degree of cross-linking within the polymeric protective layer decreases as the distance from the outer surface of the polymeric protective layer adjacent the metal layer increases. In this embodiment, an outer surface of the polymeric protective layer opposite the metal layer has the smallest degree of cross-linking, if any, relative to the degree of cross-linking of the outer surface of the polymeric protective layer adjacent the metal layer.

Suitable cross-linkable polymeric components include, but are not limited to, polyurethanes, polymers or copolymers containing polar groups thereon, polyolefins, ethylene/vinyl acetate/acid terpolymers, acrylate-based materials, acid or hydroxyl-functional polyesters, ionomers, fluoropolymers, fluoropolymer/acrylate blends, or any combination thereof. In some embodiments of the present invention, the cross-linkable polymeric components provide a polymeric protective layer that elongates, and substantially recovers to an original length (or width) when allowed to relax as long as the yield point of the polymeric protective layer is not exceeded. Such a polymeric protective layer allows a metal layer thereon to be disrupted during elongation of the polymeric protective layer, but then return to substantially its pre-elongation state once the polymeric protective layer is allowed to relax as long as the yield point of the polymeric protective layer is not exceeded.

In one exemplary embodiment, the polymeric protective layer comprises a cross-linked aliphatic waterborne polyurethane resin. Exemplary aliphatic waterborne polyurethane resins include those described in U.S. Pat. No. 6,071,621, the subject matter of which is hereby incorporated in its entirety by reference. Commercially available aliphatic waterborne polyurethanes include, but are not limited to, materials sold under the trade designation “NEOREZ” (e.g., NEOREZ SR 9699, XR 9679, and XR 9603) from Avecia (Waalwijk in The Netherlands), and materials sold under the trade designation “BAYHDROL” (e.g., BAYHYDOL 121) from Bayer Corp. (Pittsburgh, Pa.). The waterborne polyurethane resins may be formed from various types of polyols such as polyester polyols, polycarbonate polyols, and the like. The use of a polycarbonate-based polyurethane may be desirable for some applications for better anti-staining properties.

In a further exemplary embodiment, the polymeric protective layer comprises a cross-linked solvent-based polyurethane resin formed by the reaction of one or more polyols with a polyisocyanate. In some applications, it is desirable for the polyols and the polyisocyanates to be free of aromatic groups. Suitable polyols include, but are not limited to, materials commercially available under the trade designation “DESMOPHEN” from Bayer Corporation (Pittsburgh, Pa.). The polyols can be polyester polyols (e.g., DESMOPHEN 631A, 650A, 651A, 670A, 680, 110, and 1150); polyether polyols (e.g., DESMOPHEN 550U, 1600U, 1900U, and 1950U); or acrylic polyols (e.g., DEMOPHEN A160SN, A575, and A450BA/A). In one embodiment of the present invention, polyisocyanate compounds having more than two isocyanate groups are utilized to obtain cross-linked polyurethanes. Suitable polyisocyanate compounds include, but are not limited to, materials commercially available under the trade designation “MONDUR” and “DESMODUR” (e.g., DESMODUR XP7100 and DESMODUR 3300) from Bayer Corporation (Pittsburgh, Pa.).

In yet a further exemplary embodiment, the polymeric protective layer comprises a cross-linked polymer or copolymer containing (i) at least one polar group along the polymer chain, (ii) at least one olefinic portion, or (iii) both (i) and (ii). In some embodiments, the polar groups are acids groups, esters thereof, or salts thereof. For example, the polar groups are carboxylic acids, carboxylate esters, or carboxylate salts. Suitable carboxylic acids, carboxylate esters, and carboxylate salts include, but are not limited to, acrylic acid, C₁ to C₂₀ acrylate esters, acrylate salts, (meth)acrylic acid, C₁ to C₂₀ (meth)acrylate esters, (meth)acrylate salts, or combinations thereof. Suitable methacrylate and acrylate esters typically contain up to about 20 carbon atoms or up to about 12 carbon atoms (excluding the acrylate and methacrylate portion of the molecules). In some embodiments, the methacrylate and acrylate esters contain about 4 to about 12 carbon atoms.

The olefinic portion of the polymer or copolymer can be formed by free radical polymerization of monomers such as, for example, ethylene, propylene, isobutylene, or combinations thereof. In some embodiments, the olefinic materials include an olefinic monomer having ethylenic unsaturation. For example, reacting a polyethylene oligomer or ethylene monomers with a monomer having a polar group can form a copolymer for use in the polymeric protective layer.

In some embodiments, the copolymer is a reaction product of an olefinic monomer having ethylenic unsaturation with a second monomer selected from (meth)acrylic acid, a C₁ to C₂₀ (meth)acrylate ester, a (meth)acrylate salt, acrylic acid, a C₁ to C₂₀ acrylate ester, an acrylate salt, or a combination thereof. The copolymer can be prepared using about 80 to about 99 weight percent of the olefinic monomer and about 1 to about 20 weight percent or the second monomer. For example, the copolymer can be prepared by copolymerizing about 83 to about 97 weight percent of the olefinic monomer and about 3 to about 17 weight percent acrylic acid, a C₁ to C₂₀ acrylate ester, an acrylate salt, (meth)acrylic acid, a C₁ to C₂₀ (meth)acrylate ester, a (meth)acrylate salt, or combinations thereof. In another example, the copolymer contains from about 90 to about 96 weight percent of the olefinic monomer and about 4 to about 10 weight percent acrylic acid, a C₁ to C₂₀ acrylate ester, an acrylate salt, (meth)acrylic acid, a C₁ to C₂₀ (meth)acrylate ester, a (meth)acrylate salt, or combinations thereof.

When salts of a (meth)acrylate or acrylate group are present in the polymer or copolymer, the positive ion of the salt is typically an alkali metal ion, an alkaline earth metal ion, or a transition metal ion. For example, the positive ion can include, for example, sodium, potassium, calcium, magnesium, or zinc.

In some embodiments, the polymeric protective layer includes a copolymer such as, for example, ethylene (meth)acrylic acid or ethylene acrylic acid. Commercially available copolymers suitable for use in the polymeric protective layer include, but are not limited to, copolymers available from Dow Chemical Company (Midland, Mich.) under the trade designation “PRIMACOR” such as PRIMACOR 3330, which has 6.5% acrylic acid and 93.5% ethylene; copolymers commercially available from DuPont (Wilmington, Del.) under the trade designation “NUCREL” such as NUCREL 0403 (a copolymer of ethylene and methacrylic acid); copolymers commercially available under the trade designation “ELVALOY” (copolymers of ethylene with butyl acrylate, ethyl acrylate, or methyl acrylate); and copolymers commercially available under the trade designation “SURYLN” (ionomer of ethylene and acrylic acid).

In order to provide some degree of cross-linking in the polymeric protective layer, one or more of the above-described polymeric materials may be cross-linked using any known cross-linking technique including, but not limited to, (i) chemically cross-linking using reactive groups on the one or more polymeric materials, (ii) chemically cross-linking using a cross-linking additive used in combination with the one or more polymeric materials, (iii) physically cross-linking one or more polymeric materials using a cross-linking step, such as exposing the one or more polymeric materials to a cross-linking amount of radiation (e.g., electron beam radiation), or (iv) any combination of (i), (ii) and (iii).

For example, the above-described waterborne polyurethane compositions can be cross-linked by the addition of a cross-linking agent (e.g., less than about 3 weight percent) such as diaziridine. A commercially available diaziridine is sold under the trade designation “NEOCRYL” (e.g., NEOCRYL CX-100) from Avecia (Waalwijk in the Netherlands). Further, the above-described solvent-based polyurethane resin may be cross-linked, for example, by reaction with a cross-linking or curing agent such as a melamine resin. Other cross-linking agents suitable for use in the present invention include, but are not limited to, glycidyl esters, urea/formaldehyde resins, amines and amine-functional resins, and silanes.

The above-described polymers or copolymers containing (i) at least one polar group along the polymer chain, (ii) at least one olefinic portion, or (iii) both (i) and (ii), may be cross-linked, for example, using electron beam radiation. In some embodiments, the olefinic portion of the copolymer can be cross-linked, for example, using electron beam radiation. The copolymers can be cross-link by abstraction of a secondary hydrogen, resulting in the formation of a free radical intermediate. This free radical intermediate can then combine with other olefinic radicals or additional copolymers to form a higher molecular weight material. Depending on the structure of the olefinic portion of the copolymer, the free radical intermediate can undergo degradation reactions rather than reactions that increase the molecular weight by cross-linking reactions. If the olefinic portion includes polyethylene, the amount of degradation attributable to scission reactions is low. Polyethylene can cross-link when exposed to electron beam radiation whereas polypropylene has an increased tendency to undergo chain scission reactions compared to polyethylene.

Typically, the dosage is as high as possible without unduly causing the polymer to undergo chain scission reactions that are in excess of the cross-linking reactions. Loss of molecular weight can be an indicator that irradiation has unduly degraded the polymer. Accordingly, for polymers that tend to undergo chain scission reactions, the radiation dosage is typically limited such that the weight average molecular weight of the irradiated polymer is at least about 90%, at least about 95%, or at least about 99% of that of an otherwise identical copolymer that has not been irradiated. The weight average molecular weight of the cross-linked copolymer is preferably greater than the weight average molecular weight of an otherwise identical copolymer that has not been cross-linked.

In some embodiments, the electron beam radiation dosage is less than about 10 Mrads. For example, the dosage can be in the range of about 0.1 to about 10 Mrads or in the range of about 3 to about 7 Mrads. The radiation voltage can typically be up to about 600 kVolts. For example, the voltage can be in the range of about 25 to about 600 kVolts, about 50 to about 300 kVolts, or about 100 to about at about 200 kVolts. Higher voltages can be used to penetrate a greater thickness of the copolymer.

Other physical cross-linking steps suitable for use in the present invention include, but are not limited to, exposure to ionizing forms of radiation such as gamma radiation, x-rays and ultraviolet light.

Another alternative cross-linking method that is a combined chemical/physical method of cross-linking involves incorporating a sensitizing agent, such as a ultraviolet light initiator, into the polymeric layer. Exposing the film to ultraviolet light initiates a cross-linking reaction within the polymeric protective layer. This method of post-cross-linking the film increases the utility of the film by affording the user more latitude for processing the metallized film. For instance, the user of the film may desire to have greater film elongation prior to and during adhesive application to a substrate, such as during a thermoforming step. Subsequently, however, the user may desire to increase the hardness and/or thermal resistance properties of the film, after it has been adhesively attached to a substrate, in an effort to achieve a closer match of properties between the film and the substrate. This can be especially true when addressing the specific needs and balances one desires when dealing with highly elastomeric substrates or complex three dimensional parts such as automotive weatherseals.

The polymeric protective layer may further comprise one or more additives incorporated into the one or more polymeric components of the polymeric protective layer. Suitable additives include, but are not limited to, dyes, pigments, wetting agents such as surfactants, inert filler materials (e.g., glass microspheres), waxes and slip agents, UV stabilizers such as benzotriazoles and benzophenones along with hindered amine stabilizers, and combinations thereof.

When present, the one or more additives may represent up to about 50 percent by weight (pbw) based on a totals weight of the polymeric protective layer, with the balance being one or more polymeric materials. Typically, when present, each individual additive is present in an amount ranging from greater than about 0.05 pbw to about 20 pbw, preferably between about 0.1 and about 10 pbw, and most preferably between about 0.5 and about 5 pbw, based on a totals weight of the polymeric protective layer, with the balance being one or more polymeric materials.

The polymeric protective layer may also have one or more surface treatments to alter outer surface properties of the polymeric protective layer, especially the outer surface of the polymeric protective layer adjacent the metal layer (e.g., outer layer 131 of polymeric protective layer 13 shown in FIG. 1). Suitable surface treatments include, but are not limited to, a corona discharge surface treatments, flame treatments, and glow discharge surface treatments. Any surface treatment capable of chemically grafting functional groups or oxidizing the surface of the film is acceptable so long as no macroscopic degradation occurs within or on the surface of the polymeric protective layer. In one exemplary embodiment, the one or more surface treatments enhance the adhesion between the polymeric protective layer and the metal layer.

The polymeric protective layer can have a high or low gloss surface, as desired. Additionally, the polymeric protective layer can have high or low reflectivity, as desired. The polymeric protective layer is desirably transparent to visible radiation so that the underlying metal layer is visible though the polymeric protective layer. As used herein, the term “transparent” refers to materials that allow at least about 50 percent of visible radiation to pass through the materials. For example, the transparent material can pass at least about 75 percent, at least about 80 percent, at least about 85 percent, at least about 90 percent, or at least about 95 percent of visible radiation. In some applications, the polymeric protective layer is colored yet transparent. For example, the polymeric protective layer may contain dyes and/or pigments in order to provide a color to the polymeric protective layer.

The polymeric protective layer may be provided as a preformed layer such as a self-supporting film or may be cast from a solution onto a release liner. For example, when the polymeric protective layer is an aliphatic waterborne polyurethane resin, the aqueous urethane dispersion can be cast onto a release liner such as a release coated polyester film. The cast urethane dispersion can then be dried to remove water. Typically, the polyurethane is also cross-linked in the drying step, although it may be cross-linked at a later time. In another example, a solvent-free or solvent-containing mixture of a polyisocyanate and a polyol can be cast onto a release liner. The cast mixture can then be dried to remove any solvent and cured to form a cross-linked film.

When the polymeric protective layer is formed on a release liner, the release liner may be used to provide topographical features to the outer surface of the polymeric protective layer. For example, the release liner may provide a uniform pattern of valleys and/or ridges along the outer surface of the polymeric protective layer. In other embodiments, the release liner may be used to provide the outer surface of the polymeric protective layer with a substantially smooth surface. Alternatively, the release liner can impart a randomly textured or matte surface to the polymeric protective layer. Release liners suitable for use in the present invention include, but are not limited to, release liners disclosed in U.S. Published Patent Application Nos. 20040048024 and 20030129343 (now, U.S. Pat. No. 6,984,427), the disclosures of which are incorporated herein by reference in their entirety.

In other embodiments of the present invention, an outer surface of the polymeric protective layer may be embossed to provide a pattern in the outer surface prior to or after joining the polymeric protective layer with a metal layer. For example, in some embodiments, the outer surface of the polymeric protective layer opposite the metal layer may be embossed to provide a pattern on the metallized film. In other embodiments, the outer surface of the polymeric protective layer adjacent the metal layer may be embossed to provide a pattern on which a metal layer is deposited. Embossing methods suitable for use in the present invention include, but are not limited to, embossing methods disclosed in U.S. Pat. No. 5,897,930, the disclosure of which is incorporated herein in its entirety.

In some embodiments of the present invention, the outer surface of the polymeric protective layer adjacent the metal layer may be a substantially flat, smooth, planar surface having very little, if any, topographical features thereon. As used herein, the term “planar” is used to describe a surface of a layer that is substantially within the same plane. In these embodiments, a subsequently applied metal layer may provide the metallized film with a mirror-like appearance. In other embodiments of the present invention, the outer surface of the polymeric protective layer adjacent the metal layer may have a non-planar surface, such as a surface having topographical features thereon. As described above, an embossing technique may be used to provide the outer surface of the polymeric protective layer adjacent the metal layer with topographical features. Other techniques may include, but are not limited to, the use of another release liner having topographical features therein to form the outer surface of the polymeric protective layer adjacent the metal layer. In these embodiments, a subsequently applied metal layer may provide the metallized film with an alternative appearance.

The polymeric protective layer typically has an average thickness of at least about 5 micrometers (μm) although the polymeric protective layer may have any desired thickness. In some applications, the polymeric protective layer has a thickness of at least about 10 μm, at least about 15 μm, at least about 20 μm, or at least about 25 μm. The thickness of the polymeric protective layer is usually less than about 50 μm although there is no limitation on the thickness of the polymeric protective layer. In some applications, the polymeric protective layer has a thickness less than about 40 μm, less than about 35 μm, or less than about 30 μm. For example, the thickness can be in the range of about 5 to about 50 μm, or about 10 to about 40 μm, or about 20 to about 30 μm.

2. Metal Layer

The metallized films of the present invention further comprise a metal layer, such as exemplary metal layer 12 of exemplary metallized film 10. The metal layer may be opaque, reflective or non-reflective. In some embodiments, the metal layer provides a polished, mirror-like finish. Further, the metal layer may form a continuous or discontinuous pattern of metallic material between the polymeric protective layer and the polymeric primer layer.

The metal layer can be selected from a wide range of metal-containing materials such as, for example, metals, alloys, and intermetallic compositions. The metal layer can include tin, gold, silver, aluminum, indium, nickel, iron, manganese, vanadium, cobalt, zinc, chromium, copper, titanium, and combinations thereof. Examples, of combinations include, but are not limited to, stainless steel and INCONEL® alloys.

The metal layer is usually formed by deposition of metal onto the above-described polymeric protective layer. The metal can be deposited using any known technique. For example, suitable deposition methods include, but are not limited to, sputtering, electroplating, ion sputtering, or vacuum deposition. In some applications, the metal is deposited using vacuum deposition methods. Suitable metal deposition methods for use in the present invention include, but are not limited to, metal deposition methods disclosed in Foundations of Vacuum Coating Technology by D. M. Mattox, published by William Andrew/Noyes (2003), the disclosure of which is incorporated herein in its entirety.

The thickness of the metal layer can vary as needed to provide a desired surface appearance. In some embodiments, the metallized layer has an average thickness of at least 50 Angstroms. For example, the metal layer can have an average thickness of at least 100, at least 200, at least 400, at least 800, or at least 1000 Angstroms.

The metal layer may comprise a continuous pattern, for example, a metal layer comprising a single area of metallic material that substantially covers an outer surface of the polymeric protective layer. An example of this embodiment is shown in FIG. 2A, wherein exemplary metal area 30 completely covers exemplary polymeric protective layer 37 and comprises a single continuous pattern of metallic material that forms a single area of metal. In another embodiment shown in FIG. 2B, a single continuous area of metallic material 40 may be used to form a pattern such as the letter “C” on an outer surface 38 of the polymeric protective layer 37. In a further embodiment of the present invention, the metal layer may comprise a discontinuous pattern having two or more disconnected areas of metallic material on an outer surface of the polymeric protective layer such as in the exemplary embodiment shown in FIG. 2C. As shown in FIG. 2C, two disconnected areas of metallic material 50 may be used to form a discontinuous pattern comprising two separate letters “C C” on an outer surface 38 of the polymeric protective layer 37.

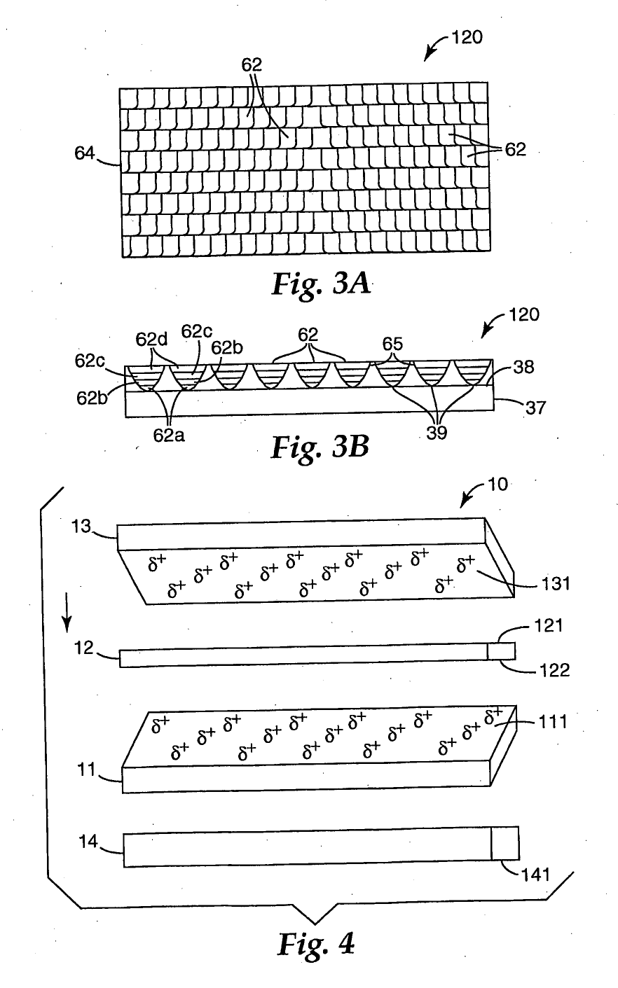

Regardless of whether the metal layer comprises a continuous pattern or a discontinuous pattern, each area of metallic material (e.g., each of exemplary metal areas 30, 40 and 50) may comprise a plurality of individual metal areas positioned adjacent to one another to form a resulting metal area, such as exemplary metal area 120 as shown in FIG. 3A. It has been discovered that, in some embodiments, enhanced corrosion resistance of a metallized film may be obtained by incorporating a metal layer containing one or more metal areas, such as exemplary metal area 120, into the metallized film. As shown in FIG. 3A, exemplary metal area 120 comprises a plurality of discontinuous metal areas 62, which form a pattern of metallic material 64. In this embodiment, although metal area 120 appears to be visually continuous, metal area 120 is discontinuous in terms of surface conductivity or resistivity.

The discontinuity of exemplary metal area 120 results in a metal layer having a surface resistivity of at least about 2 ohms/cm², desirably, at least about 10 ohms/cm². In one exemplary embodiment, the metal area has a surface resistivity of at least about 3, at least about 5, at least about 10, or at least about 20 ohms/cm². In some embodiments, it is desirable for performance reasons to have as high a surface resistivity as possible while maintaining as high an optical density that would satisfy the visual aesthetic requirements of the application.

One method of forming a metal area comprising a plurality of individual, adjacent metal area, such as exemplary metal area 120, comprises a metal deposition step, wherein the deposition step is terminated prior to or shortly after an onset of conductance within the metal area. Such a deposition step is illustrated in FIG. 3B, which depicts a cross-sectional view of exemplary metal area 120 shown in FIG. 3A. As shown in FIG. 3B, a plurality of discontinuous metal areas 62 extend upward from outer surface 38 of polymeric polymer layer 37. It is believed that, during a metal deposition procedure, each individual metal area 62 is assembled in a step-wise process, wherein a base metal deposit, such as exemplary base metal deposit 62A, first attaches to outer surface 38 of polymeric polymer layer 37 at locations 39 along, outer surface 38. Locations 39 may correspond to (i) a functional group on a polymeric material used in polymeric polymer layer 37, (ii) a functional group on an additive used in polymeric polymer layer 37, (iii) a surface treatment site resulting from one or more of the above-described surface treatments, or any combination of (i), (ii) and (iii). As shown in FIG. 3B, exemplary base metal deposit 62A are spaced apart from one another along outer surface 38 of polymeric polymer layer 37. As additional metal is deposited, one or more intermediate metal deposits, such as exemplary intermediate metal deposits 62B and 62C, result in individual metal areas 62 having an increased height (extending from outer surface 38) and a decrease in spacing between individual metal areas 62. At some point during the deposition step, if the metal deposition step is allowed to continue, individual metal areas 62 will merge with one another, forming a continuous metal area that is all electrically interconnected. Desirably, in some embodiments of the present invention, the metal deposition step is stopped such that outer peripheries of adjacent individual metal areas 62 have space therebetween such as shown in FIG. 3B. The primary driving force for the behavior of the metal during deposition is the high surface energy nature of the metal in relation to that of the organic-based polymeric layer. The relative surface energy difference does not enable a favorable interaction or wetting to occur between the metal and the polymeric layer thereby causing the metal initially be deposited into discrete microscopic domains.

As shown in FIG. 3B, outer peripheries 65 of uppermost metal deposits 62D of individual metal areas 62 are positioned close to one another, but desirably have spacing therebetween. In some embodiments, outer peripheries 65 of uppermost metal deposits 62D of individual metal areas 62 may come into contact with one another and still result in a metal area having a discontinuous conductivity. As used herein, the term “discontinuous conductivity” is used to describe a metal area or metal layer typically having a surface conductivity of less than about 0.1 mhos or a surface resistivity of at least about 10 ohms/cm² although this can vary depending on the metal used.

Typically, the amount of metal deposited on a given surface may be measured by the optical density of the metal layer, which is a measure of transmission and is obtained by taking the negative log of transmission. Although the optical density will vary with the metal being deposited, typically, the metal layer has an optic il density of less than about 2.0. For example, aluminum may have a desirable optical density lower than about 2.0, while tin may have a desirable optical density between about 2.0 and about 2.2.

It has also been discovered that maintaining a metal layer that is electrically discontinuous (i.e., has a discontinuous conductivity) provides additional benefit when formation of the metallized film involves using ionizing radiation to achieve cross-linking in the polymeric protective layer, the polymeric primer layer, or both. If the metal layer is conductive and electron beam radiation is used to cross-link one or more of the polymeric layers, the metal can act as a conductive shield, preventing electron radiation from penetrating through both layers. In acting like a shield, the conductivity of the metal layer actually creates a charge within the metal layer that exhibits massive and violent discharging, which results in considerable damage to the metal layer. This charging/discharging behavior prevents a usable film from being prepared when using electron beam to cross-link the polymeric layers. In contrast, by keeping the electrical resistance of the metal layer high, the dielectric properties of the film are maintained, which enables the use of election beam radiation to cross-link either or both of the polymeric protective and primer layers.

3. Polymeric Primer Layer

The metallized films of the present invention also comprise at least one polymeric primer layer, such as exemplary polymeric primer layer 11 of exemplary metallized film 10. At least one polymeric primer layer covers an outer surface of the metal layer opposite the above-described polymeric protective layer as shown in exemplary metallized film 10 of FIG. 1. Like the polymeric protective layer, the polymeric primer layer provides the metal layer with one or more properties: scratch resistance, impact resistance, water resistance, weather resistance, solvent resistance, resistance to oxidation, and resistance to degradation by ultraviolet radiation. Additionally, the primer layer provides a surface that can be easily adhered to by other layers, e.g., adhesives. In most embodiments, the polymeric primer layer completely covers an outer surface of the metal layer opposite the above-described polymeric protective layer such that no portion of the metal layer is exposed.

The polymeric primer layer may comprise one or more of the above-described polymeric components and optional additives suitable for use in the polymeric protective layer. Further, one or more outer surfaces of the polymeric primer layer may have one or more of the above-described surface treatments in order to alter an outer surface of the polymeric primer layer. In one exemplary embodiment, the outer surface of the polymeric primer layer adjacent the metal layer (e.g., outer layer 111 of polymeric primer layer 11 shown in FIG. 1) is surface treated using one of the above-described surface treatments. In addition, the side of the polymeric primer layer opposite the metal surface may be treated to enhance adhesive to other layers using the methods described above, e.g., corona treatment, flame treatment glow treatment, etc.

In one exemplary embodiment of the present invention, the polymeric primer layer comprises one or more thermoplastic polymeric materials so as to provide the polymeric primer layer with an outer adhesive surface opposite the metal layer. The outer adhesive surface of the polymeric primer layer can be tacky at room temperature (e.g., pressure-sensitive) or after application of heat (e.g., heat-activatable). Thermoplastic polymers suitable for use in the polymeric primer layer for providing an outer adhesive surface include, but are not limited to, polyolefins, polyurethanes, nylon, acrylics, and combinations thereof.

Suitable pressure-sensitive adhesives and heat-activatable adhesives for use in the polymeric primer layer include, but are not limited to, adhesives disclosed in U.S. Pat. No. RE024906 and EP 0384598, the disclosures of which are incorporated herein by reference in their entirety. In addition, the outer adhesive surface of the polymeric primer layer opposite the metal layer may include a surface topography to provide air-bleed capabilities to the polymeric primer layer, provide repositionability, or both.

Like the polymeric materials used to form the polymeric protective layer, at least one of the one or more polymeric materials used to form the polymeric primer layer are cross-linked. As with the polymeric protective layer, the polymeric primer layer may have various degrees of cross-linking. In some embodiments of the present invention, only an outer surface of the polymeric primer layer adjacent the metal layer is cross-linked. In other embodiments of the present invention, cross-linked polymeric material is essentially distributed throughout an entire thickness of the polymeric primer layer (i.e., the entire polymeric primer layer is subjected to a cross-linking step as opposed to just an outer surface of the polymeric primer layer). In other embodiments, the degree of cross-linking within the polymeric primer layer varies to form a cross-linking gradient along a thickness of the polymeric primer layer, wherein an outer surface of the polymeric primer layer adjacent the metal layer has a relatively high degree of cross-linking, and the degree of cross-linking within the polymeric primer layer decreases as the distance from the outer surface of the polymeric primer layer adjacent the metal layer increases. In this embodiment, an outer surface of the polymeric primer layer opposite the metal layer has the smallest degree of cross-linking, if any, relative to the degree of cross-linking of the outer surface of the polymeric primer layer adjacent the metal layer.

Suitable cross-linking methods include any of the cross-linking methods described above with regard to the polymeric protective layer. If a cross-linking gradient is desired in a portion of the metallized film, electron beam cross-linking provides the opportunity to achieve a cross-linking gradient within the polymeric protective layer, the primer layer, or the overall metallized film construction.

The polymeric primer layer may be transparent to visible radiation so that the metal layer is visible though the polymeric primer layer, i.e., the polymeric primer layer allows at least about 50 percent of visible radiation to pass through the polymeric primer layer. For example, in some embodiments, the polymeric primer layer allows at least about 75 percent, at least about 80 percent, at least about 85 percent, at least about 90 percent, or at least about 95 percent of visible radiation therethrough. In some applications, the polymeric primer layer is colored yet transparent. For example, the polymeric primer layer may contain dyes and/or pigments in order to provide a color to the polymeric primer layer.

Like the above-described polymeric protective layer, the polymeric primer layer may be provided as a preformed layer such as a self-supporting film or may be cast from a solution onto a substrate, such as a release liner or directly on the metal layer. In one exemplary embodiment, the polymeric primer layer is a self-supporting film, such as an ethylene acrylic acid (EAA) copolymer film.

When present as multiple layers, each polymeric primer layer may contribute to the overall metallized film construction. As noted above, at least a portion of the polymeric primer layer adjacent the metal layer is cross-linked. Any additional polymeric primer layers positioned away from the metal layer (i.e., adjacent another polymeric primer layer), may or may not be cross-linked. The additional polymeric, primer layer(s) positioned away from the metal layer may serve as a tie layer between the polymeric primer layer adjacent the metal layer and an additional layer (e.g. a polyolefin layer) that has less than desirable adherence to the polymeric primer layer adjacent the metal layer.

Regardless of whether the polymeric primer layer comprises a single layer or multiple layers, the polymeric primer layer adjacent the above-described metal layer has an outer surface that is adjacent to the metal layer and that conforms to the metal layer surface. For example, as discussed above, in some embodiments of the present invention, the outer surface of the polymeric protective layer adjacent the metal layer is a substantially flat, smooth, planar surface having very little, if any, topographical features thereon. In these embodiments, the subsequently applied metal layer has a substantially planar outer surface on which a polymeric primer layer is applied. In these embodiments, the outer surface of the polymeric primer layer adjacent the metal layer also has a substantially planar outer surface (e.g., a complementary outer surface to the corresponding outer surface of the polymeric protective layer). In other embodiments of the present invention, the outer surface of the polymeric protective layer adjacent the metal layer may have a non-planar surface, such as a surface having topographical features thereon. In these embodiments, the subsequently applied metal layer is a non-planar layer. In these embodiments, the outer surface of the polymeric primer layer adjacent the metal layer has complementary non-planar outer surface that matched the topographical features of the corresponding outer surface of the polymeric protective layer.

Each polymeric primer layer typically has an average thickness of at least about 5 micrometers (μm). Depending on the given application for the metallized film, a polymeric primer layer may have an average thickness of greater than 1.0 millimeter (mm) or more. Typically, a polymeric primer layer has a thickness of at least about 10 μm, at least about 15 μm, at least about 20 μm, or at least about 25 μm. The thickness of a polymeric primer layer is usually less than about 50 μm although there is no limitation on the thickness of the polymeric primer layer. In some applications, a polymeric primer layer has a thickness less than about 40 μm, less than about 35 μm, or less than about 30 μm. For example, the thickness can be in the range of about 5 to about 50 μm, or about 10 to about 40 μm, or about 20 to about 30 μm.

In some embodiments of the present invention, each of the polymeric protective layer and the polymeric protective layer independently comprise one or more cross-linked polymeric components, and at least one polymeric component in each layer has functional groups thereon resulting in a similar overall surface charge or surface polarity for (i) the outer surface of the polymeric protective layer adjacent the metal layer (e.g., outer surface 131 of polymeric protective layer 13 shown in FIG. 1), and (ii) the outer surface of the polymeric primer layer adjacent the metal layer (e.g., outer surface 111 of polymeric primer layer 11 shown in FIG. 1). An example of such an embodiment is shown in FIG. 4.

As shown in FIG. 4, each of outer surface 131 of polymeric protective layer 13 and outer surface 111 of polymeric primer layer 11 has a positive surface charge or surface polarity on either side of metal layer 12. Although not shown, it should be understood that outer surface 131 of polymeric protective layer 13 and outer surface 111 of polymeric primer layer 11 could have a negative surface charge or surface polarity on either side of metal layer 12. As explained above, polymeric component may be used to provide a particular surface charge or surface polarity to a given surface. In other embodiments, additives may be used in each layer to provide a particular surface charge or surface polarity to a given surface. For example, one or more additives selected from the following additives may be used to provide a surface charge or surface polarity to a given surface: (i) additives having thereon an acidic functional group such as sulfonic acids, phosphoric acids, phosphonic acids, boric acids, carboxylic acids, salts of these acids, esters of these acids, or combinations thereof, and (ii) additives having thereon a basic functional group such as mercapto groups, amine groups, alkoxy groups, nitrile groups, heterocyclic moieties such as those described in U.S. Pat. No. 5,081,213, and the like. Exemplary additives include, but are not limited to, benzotriazoles, oxygen or sulfur containing compounds such as mercaptosilane.

In one exemplary embodiment, the polymeric component having functional groups thereon may comprise, for example, a waterborne polyurethane, a solvent-based polyurethane, a polymer or copolymer having acidic monomers therein (e.g., an ethylene acrylic acid (EAA) copolymer), or a polymer or copolymer having basic monomers therein (e.g., polyamides, or polyacrylamide copolymers).

In some embodiments of the present invention, each of the polymeric protective and polymeric primer layers independently comprises one or more cross-linked polymeric materials alone or in combination with one or more additives, wherein at least one of the polymeric materials or additives in each layer has acidic or basic functional groups thereon. In a further exemplary embodiment, each of the polymeric protective and polymeric primer layers independently comprises one or more cross-linked polymeric materials alone or in combination with one or more additive, wherein (i) at least one of the polymeric materials or additives in each layer has acidic functional groups, (ii) at least one of the polymeric materials or additives in each layer has basic functional groups, (iii) the outer surface of either layer adjacent the metal layer has a corona discharge or glow discharge surface treatment, (iv) both (i) and (iii), or (v) both (ii) and (iii).

4. Adhesive Layer

The metallized films of the present invention may further comprise at least one adhesive layer, such as exemplary adhesive layer 14 of exemplary metallized film 10, for example, when an outer surface of the above-described corrosion-resistant metallized film does not possess a desired degree of adhesive properties (e.g., when an outer surface of the polymeric primer layer does not possess adhesive properties. In this embodiment, the adhesive layer covers an outer surface of the polymeric primer layer as shown in exemplary metallized film 10 of FIG. 1. Suitable adhesive layers include, but are not limited to, pressure-sensitive adhesive layers, heat-activatable adhesive layers, or a combination thereof. The pressure-sensitive adhesive layer may be a thermoplastic adhesive layer, a thermosettable adhesive layer, and/or a microstructured pressure-sensitive adhesive layer.

Any suitable adhesive polymer can be included in the adhesive layer. The adhesive polymer can be thermoplastic, thermosetting, or a combination thereof. The adhesive surface can be tacky at room temperature (e.g., pressure-sensitive) or after application of heat (e.g., heat-activatable). Suitable thermoplastic adhesives include, but are not limited to, polyolefins, polyurethanes, epoxies, nylon, acrylics, and combinations thereof. Suitable thermosetting adhesives include, but are net limited to, one or two part epoxies, one or two part polyurethanes, one or two part acrylics, or combinations thereof.

Suitable pressure-sensitive adhesives and heat-activatable adhesives for use in the present invention include, but are not limited to, adhesives disclosed in U.S. Pat. No. RE024906 and EP 0384598, the disclosures of which are incorporated herein by reference in their entirety.

In some embodiments, the adhesive layer on the outer surface of the polymeric primer layer comprises a pressure-sensitive adhesive, a hot melt adhesive, or a combination thereof. In one desired embodiment, the adhesive layer comprises a pressure-sensitive adhesive. When the adhesive layer has a pressure-sensitive adhesive outer surface, a release liner may be used to provide temporary protection to the pressure-sensitive adhesive outer surface.

In a further desired embodiment, the adhesive layer comprises a heat-activatable adhesive, such as a hot melt adhesive. In yet a further desired embodiment, the adhesive layer comprises a pressure-sensitive adhesive layer next to the polymeric primer layer, and a heat-activatable adhesive, such as a hot melt adhesive, on an outer surface of the pressure-sensitive adhesive layer.

Polar functional groups within the adhesive polymer (or the other above-described polymeric layers) may be used to promote adhesion between the polymeric primer layer (or the polymeric protective layer) and the metal layer, as well as adhesion between the polymeric primer layer (or the polymeric protective layer) and the adhesive layer. Representative polar groups include, but are not limited to, acids (e.g., sulfonic acids, phosphoric acids, phosphonic acids, boric acids, and carboxylic acids), salts of these acids, esters of these acids, or combinations thereof. Other representative polar groups include amine groups, alkoxy groups, nitrile groups, heterocyclic moieties such as those described in U.S. Pat. No. 5,081,213, and the like.

In some embodiments, the polar groups are acids groups, esters thereof, or salts thereof. For example, the polar groups are carboxylic acids, carboxylate esters, or carboxylate salts. Suitable carboxylic acids, carboxylate esters, and carboxylate salts include, but are not limited to, acrylic acid, C₁ to C₂₀ acrylate esters, acrylate salts, (meth)acrylic acid, C₁ to C₂₀ (meth)acrylate esters, (meth)acrylate salts, or combinations thereof. Such groups typically can provide suitable adhesion to other surfaces such as polymeric layers, metal layers, and combinations thereof.

B. Metallized Film Properties

The metallized films of me present invention may possess one or more of the following properties. Isolating and constraining the metal layer between a cross-linked polymeric protective layer and a cross-linked polymeric primer layer enables the metal layer to maintain an overall planar orientation, which is a critically important for maintaining a desirable aesthetic minor-like appearance. It also serves to achieve a level of performance when the film is exposed to elevated temperature environments during application processing steps such as heat-activated adhesive bonding, thermoforming or in actual use in the field. In prior art cases, direct contact is made between a metal layer and at least one thermoplastic layer. In this case, as the temperature is increased and approaches the softening point of the film, the metal layer becomes susceptible to movement itself that is a direct result of movement within the thermoplastic polymer layer. Simply going through a softening transition is capable of disrupting the metal layer and destroying the optical quality of the film.

It is also surprising that by isolating the metal layer between a cross-linked polymeric protective layer and the polymeric primer layer, the optical qualities of the metal layer are extremely stable to film deformation. In fact, it is very surprising that the shear magnitude of film deformation (in some cases greater than 100% or even greater than 150% film elongation) produces only a slight and acceptable loss of film opacity. In contrast, this magnitude of film deformation of a similar film construction that does not comprise cross-linked polymeric protective and primer layers produces much greater, and typically, unacceptable loss in film opacity. This loss of opacity when using a thermoplastic layer in direct contact with the metal layer is proposed to result from irreversible stretch that is not recoverable due to the plastic-like flow that occurs in the thermoplastic layer. The effect of cross-linking the film limits plastic-like flow, within the material and thus significantly reduces irreversible stretch in the film.

The metallized film comprising the polymeric protective layer, the metal layer, and polymeric prime layer serve as a standardized platform that can accommodate a variety of finished product constructions utilizing different adhesive layers. This affords the base metallized film the opportunity to be integrated into a variety of applications for the purpose of providing a stable and consistent look to various articles. For instance, the polymeric prime layer can be corona treated and an acrylic PSA laminated to the surface, which then allows the resulting metallized film to be simply laminated to a substrate such as a ‘B’ pillar post on an automobile. This provides the ‘B’ pillar a metallic chrome-like appearance. The same film construction can further be laminated with a heat-activatable adhesive, which can then be heat laminated to a weatherseal and installed on a automobile door surround, achieving the same look on the two disparate surfaces. Furthermore, the base metallized film can be thermoformed, and reinforced with a resin to provide metallic, chrome-like raised letters such as with an automotive identification badge. This can then be installed on the vehicle. In all three cases, the same base metallized film is capable of being modified to accommodate different processing conditions and adhesive requirements to provide a consistent appearance on a variety of surfaces on the automobile. This flexibility in use and application is a significant improvement over film constructions prior to the present invention.

### II. Articles of Manufacture Including a Metallized Film

The present invention is further directed to articles of manufacture, which include one or more of the above-described metallized films. The articles of manufacture of the present invention may comprise one of more of the following components in addition to the polymeric primer layer, the metal layer, the polymeric protective layer, and the optional adhesive layer described above.

A. Release Liner(s)

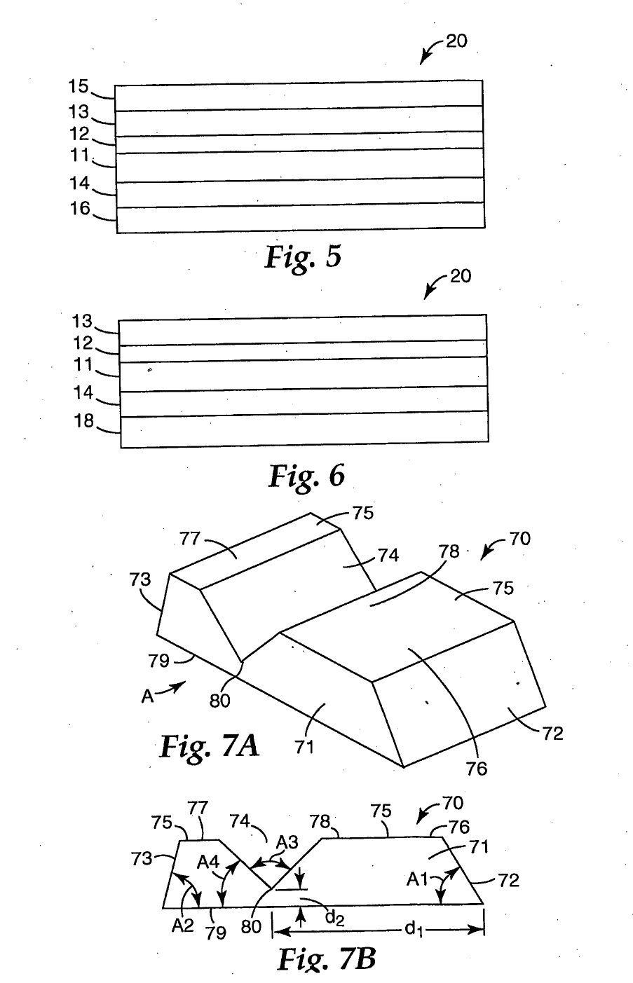

Articles of the present invention may further include at least one release liner in addition to the above-described layers of the metallized films. As described above, a first release liner may be used to provide support for the polymeric protective layer, as well as temporary protection of the polymeric protective layer prior to removal of the first release liner. When a tacky adhesive layer (e.g., a pressure-sensitive adhesive layer) is present in an article of the present invention, such as the polymeric primer layer or on an outer surface of the polymeric primer layer, a second release liner may be used to provide temporary protection of the adhesive layer prior to removal of the second release liner. Such an exemplary article is shown in FIG. 5.

As shown in FIG. 5, exemplary article 20 comprises a metallized film comprising polymeric primer layer 11, metal layer 12, polymeric protective layer 13, and adhesive layer 14. In addition, article 20 comprises a first release liner 15 on an outer surface of polymeric protective layer 13 and a second release liner 16 on an outer surface of adhesive layer 14. The presence of the first and second release liners allow a metallized film having a pressure sensitive adhesive outermost surface to be supplied in roll form. The release liner (i.e., exemplary second release liner 16 on an outer surface of adhesive layer 14 as shown in FIG. 5) can be removed for attachment of the metallized film to a surface of a substrate. The presence of the first and second release liners can also help minimize contamination of the adhesive layer on the metallized film, present damage to the polymeric protective layer, and facilitate handling of the metallized film.

The first and second release liners typically include one or more layers of materials. In some embodiments, the release liner contains a layer of paper, polyester, polyolefin (e.g., polyethylene or polypropylene), or other polymeric film material. The release liner can be coated with a material to decrease the amount of adhesion between the release liner and the adhesive layer. Such coatings can include, for example, a silicone or fluorochemical material. Any commercially available release liner may be used in the present invention.

As discussed above, first release liner 15 may be used to provide topographical features to the outer surface of polymeric protective layer 13. In addition, if desired, second release liner 16 may be used to provide topographical features to the outer surface of adhesive layer 14. For example, either release liner may provide a uniform (or non-uniform) pattern of valleys and/or ridges along an outer surface of polymeric protective layer 13 and/or adhesive layer 14. In other embodiments, either release liner may be used to provide an outer surface of polymeric protective layer 13 and/or adhesive layer 14 with a substantially smooth surface. As discussed above, release liners suitable for use in the present invention include, but are not limited to, release liners disclosed in U.S. Published Patent Application Nos. 20040048024 and 20030129343 (now U.S. Pat. No. 6,984,427), the disclosures of which are incorporated herein by reference in their entirety.

FIG. 6 provides a view of article 20 of FIG. 5 attached to a given substrate after first release liner 15 and second release liner 16 have been removed. Once second release liner 16 has been removed, article 20 may be attached to substrate 18 using pressure with or without heat. Substrate 18 may be any substrate including, but not limited to, a polymeric substrate (e.g., a film, a foam, a molded article, etc.), a glass substrate, a ceramic substrate, a metal substrate, a fabric, etc. Articles of the present invention may be useful in the preparation of various decorative items including, but not limited to, badging for automobiles and appliances, emblems, mirror films, solar reflecting films, decorative film laminates, graphics, etc. For some uses, one of the layers of article 20 may be colored.

B. Thermoformable Layer(s)

Articles of the present invention may include at least one of the above-described metallized films in combination with at least one thermoformable layer. One or more thermoformable layers may be positioned on an outer surface of the polymeric protective layer, the polymeric primer layer, or both. Thermoformable layers may be adhesively attached to the metallized film via the polymeric primer layer or an additional adhesive layer, or may be a component (e.g., a layer) used during the formation of the polymeric protective layer, the polymeric primer layer, or both. The resulting thermoformable article comprising at least one of the above-described corrosion-resistant metallized films in combination with at least one thermoformable layer may be thermoformed to form a thermoformed article comprising a corrosion-resistant metallized film. Any conventional thermoforming technique (e.g., molding) may be used to form the thermoformed article. Thermoformable materials suitable for use in the present invention include, but are not limited to, any thermoplastic material, a thermosettable material, or a combination thereof. Thermoplastic materials such as ABS (acrylonitrile/butadiene/styrene), polycarbonate, polyester, polyurethane, polypropylene, polyethylene, and polyolefin blends are examples of useful thermoformable materials. In one desired embodiment, the thermoformable layer comprises an engineering thermoplastic material. Suitable engineering thermoplastic materials include, but are not limited to, polycarbonates, polyesters (e.g., polybutylene terephthalate), some polyethylenes, polyamides, polysulfones, polyetheretherketones (PEEK), ABS (acrylonitrile/butadiene/styrene), SAN (styrene/acrylonitrile), polyurethanes, polyacrylics, and blends thereof.

In a further desired embodiment, the thermoformable article comprises at least one of the above-described metallized films in combination with a polycarbonate or polyester thermoformable layer. The polycarbonate or polyester thermoformable layer may be bonded directly to an outer adhesive surface of the polymeric primer layer (e.g., when the polymeric primer layer comprises a cross-linked PSA) or to an additional adhesive layer (e.g., a PSA layer) on an outer surface of the polymeric primer layer.

The resulting thermoformable or thermoformed articles may be used in a variety of applications. In one exemplary embodiment, the thermoformable or thermoformed articles are used in signage, such as outdoor signage and backlit displays. Such displays typically comprise a box, which houses a light fixture, wherein the front face of the box housing is covered with a film. One such device in which the front face is covered with a transparent film is described in U.S. Pat. No. 5,224,770, the disclosure of which is hereby incorporated in its entirety by reference. Another such device in which the front face is covered with a perforated film is described in U.S. Patent Publication No, 2002/0034608, the disclosure of which is hereby incorporated in its entirety by reference. In the '608 publication, a perforated film is placed over a housing so that the film reflects light during the day to display an image, but can be backlit at night to illuminate an image from behind the film.

In the present invention, the metallized films may be used similar to the transparent film in the '770 patent and the '608 publication. The metallized films of the present invention and thermoformable or thermoformed articles made therefrom have sufficient light transmission, typically about 15-25% light transmission, so as to illuminate the sign from the backside at night or in the dark. The metallized films desirably comprise enough metal coated on the film so as to reflect light during the daytime or in a lit room to display an image, e.g. a three-dimensional image that was thermoformed in the film. In one specific embodiment of the present invention, the film is imaged (e.g., graphics are applied to the metallized film) on the polymeric protective layer side and is then coated with a pressure sensitive or heat activated adhesive on the polymeric primer side. The film can then be laminated to a suitable polymeric material, such as an engineering thermoplastic, and then thermoformed to a desired shape to form a cover for a housing containing a light. Alternatively, the film can be laminated to the thermoplastic and thermoformed to provide a three dimensional image. Such constructions are suitable for daylight/nighttime signage.

C. Additional Top Coat Layer(s)

Articles of the present invention may include at least one of the above-described metallized films in combination with one or more additional top coat layers provided on an outer surface of the polymeric protective layer. Suitable top coat layer materials include, but are not limited to, polymeric materials used to form the above-described polymeric protective layer. When present, the one or more additional top coat layers (i) provide some form of protection to the polymeric protective layer (e.g., UV protection, scratch resistance, weather resistance, etc.), (ii) acts as a tie layer between the polymeric protective layer and an additional layer that has less than desirable adherence to the polymeric protective layer (e.g. a polyolefin layer), or (iii) both (i) and (ii).

D. Permanently Attached Substrate(s)

Articles of the present invention may include at least one of the above-described metallized films in combination with one or more permanently attached substrate layers provided on an outer surface of the polymeric protective layer, the polymeric primer layer or both. As discussed above, suitable substrate layers (e.g., exemplary substrate 18 shown in FIG. 6) include, but are not limited to, a polymeric substrate (e.g., a film, a foam, a molded article, etc.), a glass substrate, a ceramic substrate, a metal substrate, a fabric, etc. In one desired embodiment of the present invention, the substrate comprises an elastomeric substrate.

The elastomeric substrate can be a thermoset material formed, for example, by cross-linking an ethylene-propylene-diene monomer. Alternatively, the elastomeric substrate can be a thermoplastic material formed, for example, by blending a rubbery material with a thermoplastic material. Suitable thermoplastic materials include, but are not limited to, polyethylene, polypropylene, and polyvinyl chloride. Suitable rubbery materials include, but are not limited to, ethylene-propylene lubbers, ethylene-propylene-diene rubbers, nitrile rubbers, polychloroprene, chlorosulfonated polyethylene, and styrene butadiene rubbers. The rubbers can be vulcanized, dynamically vulcanized or non-vulcanized. Commercially available elastomeric substrate materials include, but are not limited to, SANTOPRENE™, VYRAM™, GEOLAST™, TREFSIN™, VISTAFLEX™, and DYTRON™. The thermoplastic or thermoset material is often compounded with a variety of additives and fillers such as carbon black, stabilizers, plasticizers, and the like.

The amount of thermoplastic or thermoset material can vary widely depending upon the physical properties sought for the application and is typically at least about 15 weight percent based on the weight of the elastomeric material. In some embodiments, the weight of thermoplastic material is no greater than about 85 weight percent, no greater than about 70 weight percent, or no greater than about 60 weight percent based on the weight of the elastomeric material. The amount of rubbery material is at least about 5 weight percent based on the weigh to the elastomeric material. In some embodiments, the weight of the rubbery material is no greater than about 85 weight percent, no greater than about 70 weight percent, or no greater than about 60 weight percent based on the weight of the elastomeric material.

In some elastomeric materials, the weight ratio of rubbery material to thermoplastic or thermoset material is from about 5:95 to about 95:5. For example, the weight ratio of rubbery material to thermoplastic or thermoset material can be from about 20:80 to about 80:20, from about 30:70 to about 70:30, or from about 40:60 to about 60:40.

In one desired embodiment of the present invention, the article comprises at least one of the above-described metallized films permanently attached to a substrate layer in the form of an elastomeric weatherseal. In this embodiment, the metallized film may be permanently attached to the weatherseal via a heat-activatable adhesive layer alone or in combination with a separate pressure-sensitive adhesive layer positioned between the heat-activatable adhesive layer and the metallized film. For example, a heat bond laminator, such as Heat-Bond Laminator MODEL TE 2417 from EHVO GmbH (Kuehnheide, Germany), may be used to preheat a weatherseal (e.g., an EPDM rubber profile) directly before contacting the weatherseal with the heat-activated adhesive surface of the metallized film. An exemplary temperature of the air stream used to pre-heat the weatherseal may be about 650° C. at a flow rate of about 90 liters/min. The tape application speed can be about 12 m/min with an infrared radiation setting at 55%.

### EXAMPLES

### Example 1

A polyurethane dispersion was prepared by mixing 93.64 parts of Alberdingk-Boley PUD resin U933 (water-based polycarbonate polyurethane dispersion available from Alberdingk-Boley Inc. (Charlotte, N.C.)), 4.86 parts of UV (ultraviolet light) stabilizer solution, and 1.5 parts of aziridine solution. The UV stabilizer solution was prepared by mixing 10.2 parts of TINUVIN® 292 (hindered amine light stabilizer available from Ciba Specialty Chemicals Corp. (Tarrytown, N.Y.)), 17.3 parts of TINUVIN® 1130 (hydroxyphenyl benzotriazole type UV absorber available from Ciba Specialty Chemicals Corp. (Tarrytown, N.Y.)), 3.9 parts of TRITON™ GR-7M (sodium sulfosuccinate surfactant available from Union Carbide Corp. (Danbury, Conn.)), 9 parts of AMP-95 (aminomethyl propanol, a pH adjuster available from Angus Chemical Co. (Buffalo Grove, Ill.)), and 66.7 parts of deionized water to form a clair yellowish solution. The aziridine solution was 50 parts of NEOCRYL® CX-100 (polyfunctional aziridine available from Neoresins, Inc. (Wilmington, Mass.)) in 50 parts of deionized water.

The polyurethane dispersion was coated to a thickness of approximately 127 μm (5 mils) onto a bare polyester film using a notch-bar coater. The dispersion was dried and cured in a three zone oven with temperatures set at 190°, 350°, and 350° F. in Zones 1,2, and 3, respectively to form a film having a thickness of about 25.4 μm (1 mil). Each zone was about 3.66 m (12 feet) long. The film was treated by oxygen glow using a current of 50 mA at a line speed of 9.14 mpm (30 ft/min). The oxygen flow into the glow chamber was 195 sccm under a vacuum of 3×10−2 torr.

The polyurethane film on the polyester film was loaded around the cooling drum of a metal vapor coating chamber with the polyurethane side away from the drum. The cooling drum temperature was set at 15.6° C. (60° F.) and the chamber was pumped down to a vacuum of about 3×10⁻⁵ torr. Behind a shuttered aperture, an electron beam gun was used to heat two graphite crucibles holding tin by gradually increasing the power to a setting of 220 milliAmps. The film was pulled over the cooling drum at a speed of 3.05 m/minute (10 feet/minute) past the partially opened aperture exposing the film to vaporous tin and allowing the tin to condense onto the web to form a metallized polyurethane film.

A 30.5 μm (1.2 mil) thick layer of EAA (ethylene acrylic acid commercially available under the trade designation PRIMACOR 3330 from Dow Chemical Co. (Midland, Mich.)) was extruded onto a polyester release film. The EAA layer was cross-linked by exposing it to 5 Mrads of electron beam radiation at 175 kV, and then laminated to the metal layer of the polyurethane film using a hot can set at 129.4° C. (265° F.).

The EAA side of the film laminate was corona treated in a nitrogen atmosphere at a speed of 3.05 m/minute (10 feet/minute) with a power setting of 26 Hz and 250 watts and then laminated to a layer of acrylic pressure-sensitive adhesive on a release liner using a nip roll heated to about 65.6° C. (150° F.). The acrylic adhesive had a composition of 81 parts of isooctyl acrylate and 19 parts of acrylic acid. The acrylic adhesive was then bonded to a layer of primed thermoplastic heat-activatable adhesive. The heat-activatable adhesive was a thermoplastic copolymer of ethylene and propylene (PP7035E5 IMPACT Copolymer available from ExxonMobil Chemical Co., Houston, Tex.). The adhesive was primed by grafting N,N-dimethyl acrylamide onto the surface using electron beam radiation according to the procedure described in EP 0384598, the subject matter of which is hereby incorporated in its entirety by reference. The resulting laminate was then heat bonded to a wing-shaped weatherseal using a heat pressure laminator, Model WL-30 Laminator, 3M Company (St. Paul, Minn.), by heating the weatherstrip surface and the heat-activatable adhesive side of the metallized laminate with a stream of hot air just before the two surfaces are laminated together using the applicator wheel of the laminator. The weatherseal was formed from a dynamically vulcanized elastomer that was a blend of propylene and EPDM rubber commercially available from Advanced Elastomer Systems, LP (Akron, Ohio) under the trade designation SANTOPRENE™.

The resulting weatherseal had a specular appearance that could be deformed by (i) pressing on it with hand pressure or (ii) by wrapping the composite article completely around a 6.35 mm (0.25 inch) mandrel without losing its metal-like appearance.

The amount of deformation that the chrome film can withstand without losing its opacity and reflective qualities was evaluated by measuring the film properties of the metallized film, i.e., the polyurethane film, the metal layer, and the EAA layer, before and after stretching it to varying lengths shown in Table 1. The Films were stretched using an Instron Tensile Tester. A 2.54 cm (1 inch) by 7.62 cm (3 inch) sample of film was placed in the jaws of the tester with a gap setting between the jaws of 5.08 cm (2 inches). The positions where the jaws clamped the film (indicating the Original Length of 5.08 cm (2 inches)) were marked on the film. The jaws were opened slowly to a Stretched Film Length of 6.35 cm (2.5 inches), indicating an elongation of 1.27 cm (0.5 inch) or correspondingly to an elongation of 25%. The film was left i n the jaws for about 15 seconds, and the jaw positions were marked again. The film was removed from the jaws and measured for the following properties:

Optical density (Opt Density)—Light transmittance of the film was measured using a Macbeth TD504 optical instrument. The optical density was calculated by taking the negative logarithm of the measured light transmittance of the film. Typically, the optical density ranges from about 0.8 to about 1.2 or higher, although the range can vary depending upon the metal and the desired appearance.

Surface resistivity (Surf Resistivity)—The surface resistivity was measured using a 717 Conductance monitor manufactured by Decom Instruments Inc. A film sample was placed between the sample probe, measured, and the surface resistivity was recorded in ohms/cm². No Response (NR) indicates that no conductivity could be measured.

% Elastic Recovery (% ER)—This was the amount of recovery that the film underwent after removing the film from the jaws. The film was allowed to come to a Final Film Length by laying the sample on a flat surface for it least an hour at ambient temperature (about 22° C.) before measuring. Most of the recovery of the film occurred within the hour. The Original Length of all of the samples was consistently 5.08 cm (2 inches). The % ER was calculated follows:

% ER=[(Stretched Film Length−Final Film Length)/Original Length]×100

% Hysteresis (% HYS)—This was the amount of permanent deformation that the film underwent after stretching and is the difference between the % Stretch and the % Elastic Recovery. (% HYS=(% Stretch−% ER))

Further film samples were also stretched to Stretched Film Lengths shown in Table 1 and tested as described above.

TABLE 1
Metallized Film Properties

| | Stretched | Final | | | | | | |
|---|---|---|---|---|---|---|---|---|
| | Length | Length | | % | Surf Resistivity | | Opt Density | |
| % Stretch | cm (in) | cm (in) | % ER | HYS | Before | After* | Before | After |
| 25 | 6.35 | 5.398 | 18.75 | 6.25 | 8.4 | 8.3 | 1.48 | 1.41 |
| | (2.5 in) | (2.125 in) | | | | | | |
| 50 | 7.62 | 6.032 | 31.2 | 18.8 | 6.4 | 13.8 | 1.54 | 1.27 |
| | (3 in) | (2.375 in) | | | | | | |
| 75 | 8.89 | 6.828 | 40.6 | 34.4 | 6.3 | 20.5 | 1.58 | 1.18 |
| | (3.5 in) | (2.688 in) | | | | | | |
| 100 | 10.16 | 7.780 | 46.8 | 53.2 | 6.4 | 56 | 1.54 | 1.09 |
| | (4 in) | (3.063 in) | | | | | | |
| 125 | 11.43 | 8.758 | 52.6 | 72.4 | 7.1 | 178 | 1.52 | 0.99 |
| | (4.5 in) | (3.448 in) | | | | | | |
| 150 | 12.7 | 9.525 | 62.5 | 87.5 | 11.5 | NR | 1.53 | 0.94 |
| | (5 in) | (3.75 in) | | | | | | |

*NR = No Response

The metallized film laminate with the heat activated adhesive layer was also tested as described above and the properties of the film were measured. The film laminate construction, from top to bottom, was polyurethane film, metal layer, EAA layer, acrylic adhesive layer, and heat-activatable adhesive layer.

TABLE 2
Metallized Film Laminate Properties With Heat Activated Adhesive Layer

| | Stretched | Final | | | | | | |
|---|---|---|---|---|---|---|---|---|
| | Length | Length | | % | Surf Resistivity | | Opt Density | |
| % Stretch | cm (in) | cm (in) | % ER | HYS | Before | After* | Before | After |
| 25 | 6.35 | 5.398 | 18.75 | 6.25 | 36 | NR | 1.5 | 1.37 |
| | (2.5 in) | (2.125 in) | | | | | | |
| 50 | 7.62 | 6.350 | 25 | 25 | 23 | NR | 1.5 | 1.19 |
| | (3 in) | (2.5 in) | | | | | | |
| 75 | 8.89 | 6.985 | 37.5 | 37.5 | 32 | NR | 1.47 | 1.12 |
| | (3.5 in) | (2.75 in) | | | | | | |
| 100 | 10.16 | 8.098 | 40.6 | 59.4 | 27 | NR | 1.54 | 0.99 |
| | (4 in) | (3.188 in) | | | | | | |
| 125 | 11.43 | 9.368 | 40.6 | 84.4 | 34 | NR | 1.36 | 0.94 |
| | (4.5 in) | (3.688 in) | | | | | | |
| 150 | 12.7 | 9.682 | 59.4 | 90.6 | 39 | NR | 1.5 | 0.93 |
| | (5 in) | (3.812 in) | | | | | | |

*NR = No Response

The data in Table 1 show that after stretching as much as 150%, the films of the present invention maintain their metallic appearance. Surprisingly, the above data demonstrated a surprisingly low amount of loss in optical density after stretching and an equally surprising increase in surface resistivity.

The films of Example 1 were also tested for tensile and elongation. Test results are shown in Table 3. The films were tested on a Instron Tensile Tester using a 2.54 cm (1 inch) wide sample. The metallized film construction was polyurethane layer, metal layer, and EAA layer. The film laminate construction was polyurethane layer, metal layer, EAA layer, the acrylic adhesive layer and heat activatable adhesive layer. The heat activatable adhesive layer was also tested by itself.

TABLE 3
Tensile and Elongation Properties

| | Metallized Film | | Film Laminate | | Heat Activated Adhesive | |
|---|---|---|---|---|---|---|
| | Avg | Std Dev | Avg | St Dev | Avg | Std Dev |
| Sample | 53.34 | 0 | 137.16 | 0 | 66.04 | 0 |
| Thickness | (0.0021 in) | | (0.0054 in) | | (0.0026 in) | |
| μm (in) | | | | | | |
| Peak Load | 14.635 | 0.942 | 21.289 | 0.49 | 11.119 | 0.75 |
| Nm (lbf) | (10.793 lbf) | | (15.7 lbf) | | (8.2 lbf) | |
| Modulus | 62.12 | 10082.9 | 50.55 | 7649 | 73.43 | 9572 |
| kN/cm² (psi) | (90090.5 psi) | | (73311 psi) | | (106502 psi) | |
| Elongation (%) | 149.8 | 22.2 | 388 | 309 | 490 | 43.9 |
| Real Tensile | 35.437 | 3.09 | 20 | 0.6 | 21.8 | 1.99 |
| Strength (Mpa) | | | | | | |
| Yield Index | 11 | 2 | 9 | 1 | 8 | 1 |
| No. of Samples | 3 | 3 | 6 | 6 | 3 | 3 |

During testing of the film laminate, it was observed that the film maintained its cohesive strength up to approximately 200% elongation at which point in half of the samples that exhibited the highest overall elongation, the clearcoat film, i.e., polyurethane layer, ruptured causing a drop in the tensile force while continuing to elongate. This continued until approximately 450% elongation at which point the primer layer (EAA film) ruptured leaving the heat-activatable adhesive holding the film structure together. The film laminate continued to elongate until it failed between 550 and 602% elongation. For the other samples, the films simply ruptured or broke as a cohesive film.

### Comparative Example 1

A metallized film laminate was prepared according to the procedure of Example 1 except that instead of the ethylene acrylic acid layer, a 12.7 μm (0.5 mil) thick layer of a thermoplastic polyamide (MACROMELT 6240 available from Henkel Adhesives (Elgin, Ill.). The polyamide was coated onto a paper release liner and hot laminated to the metal layer using a nip set at a temperature of 110° C. (230° F.) to form a film laminate. The film laminate was stretched according to the procedure of Example 1 and the film properties as well as the optical density and surface resistivity were measured. The original length was 5.08 cm (2 inches). Test results are shown in Table 4.

TABLE 4
Metallized Film Laminate Properties With Polyamide Layer

| | Stretched | Final | | | | | | |
|---|---|---|---|---|---|---|---|---|
| | Length | Length | | % | Surf Resistivity | | Opt Density | |
| % Stretch | cm (in) | cm (in) | % ER | HYS | Before | After* | Before | After |
| 25 | 6.35 | 5.398 | 18.75 | 6.25 | 9 | 11 | 1.74 | 1.48 |
| | (2.5 in) | (2.125 cm) | | | | | | |
| 50 | 7.62 | 6.668 | 18.75 | 31.25 | 11 | 60 | 1.72 | 1.16 |
| | (3 in) | (2.625 in) | | | | | | |
| 75 | 8.89 | 7.7788 | 21.88 | 53.12 | 13 | 244 | 1.68 | 1.02 |
| | (3.5 in) | (3.0625 in) | | | | | | |
| 100 | 10.16 | 8.7312 | 28.13 | 71.875 | 25 | NR | 1.6 | 0.89 |
| | (4 in) | (3.4375 in) | | | | | | |
| 125 | 11.43 | 9.842 | 31.25 | 93.75 | 74 | NR | 1.51 | 0.83 |
| | (4.5 in) | (3.875 in) | | | | | | |
| 150 | 12.7 | 10.9538 | 34.38 | 115.62 | NR | NR | 1.39 | 0.68 |
| | (5 in) | (4.3125 in) | | | | | | |

NR = No Response

The test results show that there is a greater amount of hysteresis at higher elongations which appear to correspond with more disruption of the metal layer resulting in a lower optical density.

### Example 2

A polyurethane dispersion resin supplied by Industrial Copolymers Ltd. under the trade designation INCOREZ 007/129 was coated onto a bare PET liner at a wet thickness of 8 mils using a notch bar coating apparatus. The coated liner was placed in a 60° C. (140° F.) oven for 1 hour to insure that the coating was completely dry. This film was then placed in a Denton Vacuum (DV-502A) evaporative lab coater. Two ‘shots’ of tin were loaded into each of the 6 tungsten wire baskets, while the film was taped to an inside surface of the bell. The bell was placed over the chamber and pumped down to a vacuum of approximately 1×10⁻⁵ torr. This operation took approximately 20 minutes. The power load to the wire baskets was raised until a power level of 35 was achieved. The ramp-up took approximately 2 minutes, and was held at a power level of 35 for about 45 seconds. The power load was then rapidly decreased to the first post. The operation was repeated for the second wire basket post. The machine sat for approximately 10 minutes. The chamber of the machine was then purged with nitrogen until atmospheric pressure was achieved.

The film exhibited some areas of whitening due to the heating effect of the baskets but the samples were highly reflective on the surface facing the liner. This sample was then laminated to an EAA primer layer as used in Example 1 at 129.4° C. (265° F.) at moderate to slow lamination speeds on the laboratory laminator used in Example 1. This film sample was then thermoformed using female thermoforming mold having the letters ‘JEEP’ on them that were about 1.5 mm deep. The molds were then coated with a two-part polyurethane resin which filled the mold and formed a thin layer of polyurethane on the back side of the sheet. The polyurethane was covered with a 12.7 μm (0.5 mil) thick film of MACROMELT 6240, and laminated to a layer of acrylic foam tape. The thermoforming, backfilling, and lamination processes are described in EP 0392847. The sample was allowed to cure for approximately 10 minutes and the resulting sheet with the letters ‘JEEP’ on it was then removed from the mold.

The sheet was then cut in half. Half of the sheet was run through a PPG Industries Inc. UV processor model QC1202 in the laboratory 5 times at 30.48 mpm (100 fpm) with both UV lamps on a “Full” setting. After exposure, the sheet on the film side of the sample curled, which suggested that there was some cure in the polyurethane clearcoat film due to curing that occurred upon exposure to UV. Samples of the clear polyurethane film were also evaluated for tensile and elongation, with and without exposure to UV radiation as described above. The tensile and elongation results shown in Table 5 were an average of 3 samples.

TABLE 5
Tensile & Elongation for Example 2

| | | | Modulus | Elonga- | Real |
|---|---|---|---|---|---|
| | Thickness | Peak Load | kN/cm² | tion | Tensile |
| Sample | μm (inch) | Nm (lbf) | (psi) | (%) | (Mpa) |
| Unexposed | 30.48 | 8.11 | 27.22 | 213 | 34.4 |
| | (0.0012 in) | (5.98 lbf) | (39481 psi) | | |
| UV Exposed | 30.48 | 9.00 | 55.21 | 144 | 38.2 |
| | (0.0012 in) | (6.64 lbf) | (80067 psi) | | |

These samples clearly show that there was some level of post-cure of the film as evidenced by the higher tensile and lower elongation of the UV exposed sample. The pre-exposed film enables a user to achieve a high degree of thermoforming definition in a formed part. After exposure to UV, to cross-link the film, a harder, more durable film is obtained with better definition of details from the thermoforming operation. It should also enable the achievement of better overall performance such i s solvent resistance and overall durability in the film by having a post cross-linking step.

### Example 3

A film laminate is prepared according to the procedure of Example 1 except that a layer of polyurethane is laminated to the metal coating instead of the EAA layer. The polyurethane layer is laminated using a hot can with a temperature setting of about 121.1° C. (250° F.). The second polyurethane film is laminated to a heat-activatable adhesive using an acrylic pressure-sensitive adhesive. The heat-activatable adhesive is then laminated to a wing shaped weatherseal as described in Example 1.

### Example 4

A film laminate is prepared according to the procedure of Example 1 except that a 1 mil thick layer of EAA is laminated to the polyurethane, and the EAA surface is metallized. A second EAA layer is laminated to the metal coating, and further layers are laminated as described in Example 1.

### Example 5

A metallized polyurethane film comprising a layer of EAA was prepared according to the procedure in Example 1 except that the dispersion was prepared using 48.82 parts of Alberdingk-Boley PUD resin U933, and 48.82 parts of Alberdingk-Boley PUD resin U911 (water-based polycarbonate polyurethane dispersions available from Alberdingk Boley Inc. (Charlotte, N.C.)), 4.86 parts of UV (ultraviolet light) stabilizer solution, and 1.5 parts of aziridine solution. The UV stabilizer solution was prepared by mixing 10.2 parts of TINUVIN® 292 (hindered amine light stabilizer available from Ciba Specialty Chemicals Corp. (Tarrytown, N.Y.)), 17.3 parts of TINUVIN® 1130 (hydroxyphenyl benzotriazole type UV absorber available from Ciba Specialty Chemicals Corp. (Tarrytown, N.Y.)), 3.9 parts of TRITON™ GR-7M (sodium sulfosuccinate surfactant available from Union Carbide Corp. (Danbury, Conn.)), 9 parts of AMP-95 (aminomethyl propanol, a pH adjuster available from Angus Chemical Co. (Buffalo Grove, Ill.)), and 66.7 parts of deionized water to form a clear yellowish solution. The aziridine solution was 50 parts of NEOCRYL® CX-100 (polyfunctional aziridine available from Neoresins, Inc. (Wilmington, Mass.)) in 50 parts of deionized water.

The EAA side of the film was laminated to a layer of cross-linked acrylic pressure-sensitive adhesive on a release liner. The hot melt acrylic adhesive had a composition of 95.42 parts 2-methyl butyl acrylate, 3.98 parts acrylamide and 0.60 parts benzophenone that had been cross-linked by exposure to 500 mJ/cm² of UV-A radiation from a medium pressure mercury lamp.

### Example 6

A metallized polyurethane film was prepared according to the procedure of Example 5 except that the EAA layer was omitted and the cross-linked pressure-sensitive adhesive was laminated directly to the metal layer to form an adhesive layer having a thickness of 38.1 μm (1.5 mils).

### Examples 7-8 and Reference Example R1

The film for Reference Example R1 was Scotchcal™ 3635-110 film available from 3M Company, Commercial Graphics Division, St. Paul, Minn.

Sheets of 1.59 mm (0.0625 inch) polycarbonate (available from McMaster Carr (Elmhurst, Ill.)) measuring 30.5 cm (12 in) by 30.5 cm (12 in) were dried for 3 hours at 65.6° C. (150° F.). The pressure-sensitive adhesive sides of the metallized films of Examples 5 and 6 and of Reference Example R1 were laminated to the polycarbonate sheet to form laminated stack samples. The laminated stack samples were dried at 65.6° C. (150° F.) for 12 hours. After the stacks had cooled to ambient room temperature, the specularity of the samples was measured according to the procedure described below.

The samples were thermoformed on a Labform 2024 Thermoformer (available from Hydro-Trim Corporation (W. Nyack, N.Y.)) with the polycarbonate side of the stack against the surface of a mold made of medium density fiberboard and having a mold configuration as shown in FIGS. 7A-7B. The stack was heated on both sides for 90 seconds using an oven set at an oven temperature of 229.4° C. (445° F.). The stack was then vacuum formed over the mold for 9 seconds.

As shown in FIGS. 7A-7B, the mold 70 was rectangular having overall length and width dimensions of about 17.8 cm (7 in) by 17.8 cm (7 in) and a height of 3.8 cm (1.5 in). The opposing width edges 71 each had an enclosed angle of 80 degrees. The length edges had an enclosed angle A1 of 60 degrees on one edge 72 and an enclosed angle A2 of 75 degrees on the opposing edge 73. Mold 70 had a V-shaped groove 74 with a 90 degree enclosed angle A3, and positioned a distance, d₁, of 8.9 cm (3.5 in) from edge 72 having an enclosed angle A1 of 60 degrees. Groove 74 divided the planar surface 75 of mold 70 into a large planar surface 76 and a small planar surface 77 with a bottom 80 of groove 74 positioned 9.6 mm (0.38 in) above lower edge 79.

The specularity of each thermoformed film samples was measured as described above in an area 78 on large planar surface 76. A corresponding area of a given film sample had undergone a draw of approximately 10% in area 78. The films of both examples produced thermoformed sheets with highly specular films on the top surface while Reference Example R1 had a diffuse reflective surface.

The reflectivity measurements were conducted on a spectrocolorimeter (GretagMacBeth Color-Eye 7000 UV available from GretagMacBeth (New Windsor, N.Y.)). The reflectivity, as a function of wavelength bandpass (from about 350-750 nanometers), was measured for each sample so as to include the specular component and so as to exclude the specular component. The degree of specularity of a given film was determined by calculating the difference in the values of the spectral reflectivity when the specular component was included and when the specular component was excluded. A low value in the reflectivity, i.e., a small difference, at a given bandpass indicates a diffuse reflecting film, i.e., not mirror-like, while a large value indicates a highly specular film, i.e., mirror-like.

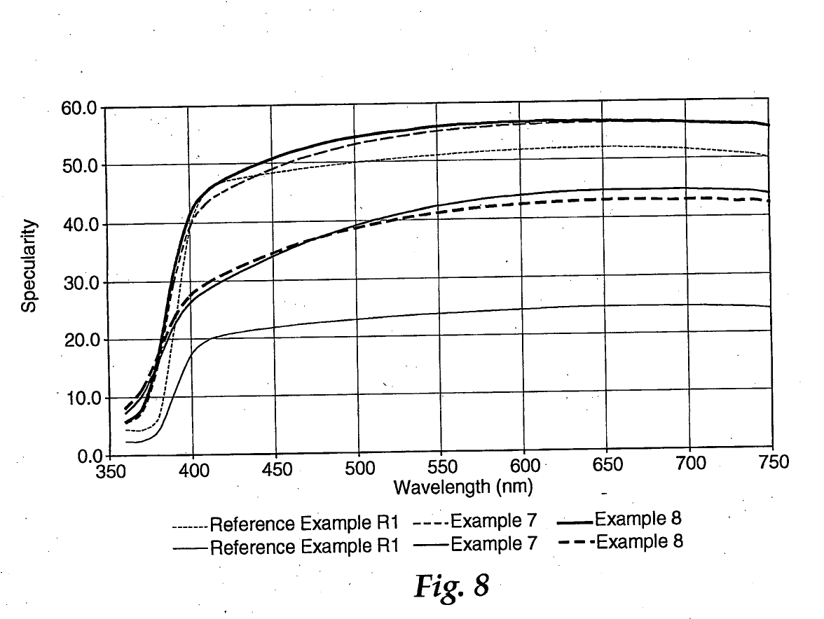

Table 6 below provides (i) the degree of specularity, i.e., the difference between the values with and without the specular component, for the film samples of Examples 7 and 8 and Reference Example R1 prior to being thermoformed and (ii) the degree of specularity of a given film after being thermoformed. A plot of the difference in specularity for each film sample (i.e., Example 7 and 8 and Reference Example R1) is shown in FIG. 8. As shown in FIG. 8, Example 7 and 8 of the present invention exhibited a smaller difference in specularity resulting from the thermoforming process step compared to Reference Example R1 (i.e., as shown by the greater distance between line pairs of Reference Example R1).

TABLE 6
Specularity of Films Before and After Thermoforming

| | Specularity | | | | | |
|---|---|---|---|---|---|---|
| Wavelength | Before | After | Before | After | Before | After |
| (nm) | R1 | R1 | Ex 7 | Ex 7 | Ex 8 | Ex 8 |
| 360 | 4.2 | 2.3 | 5.6 | 7.8 | 5.8 | 8.2 |
| 370 | 4.1 | 2.5 | 7.7 | 10.9 | 8.1 | 11.4 |
| 380 | 6.6 | 4.5 | 15.9 | 16.6 | 16.7 | 17.3 |
| 390 | 20.9 | 11.0 | 29.9 | 22.9 | 30.8 | 23.6 |
| 400 | 37.3 | 17.2 | 39.6 | 26.8 | 40.3 | 27.6 |
| 410 | 43.2 | 19.7 | 43.4 | 29.0 | 44.0 | 29.6 |
| 420 | 44.8 | 20.6 | 45.3 | 30.5 | 45.9 | 31.1 |
| 430 | 45.5 | 21.1 | 46.7 | 32.0 | 47.2 | 32.4 |
| 440 | 46.1 | 21.5 | 48.0 | 33.3 | 48.4 | 33.6 |
| 450 | 46.6 | 21.8 | 49.1 | 34.6 | 49.4 | 34.7 |
| 460 | 47.1 | 22.1 | 50.1 | 35.8 | 50.4 | 35.7 |
| 470 | 47.5 | 22.4 | 51.0 | 36.9 | 51.1 | 36.6 |
| 480 | 47.9 | 22.6 | 51.8 | 37.9 | 51.8 | 37.4 |
| 490 | 48.2 | 22.8 | 52.5 | 38.9 | 52.5 | 38.1 |
| 500 | 48.6 | 23.0 | 53.2 | 39.7 | 52.9 | 38.8 |
| 510 | 48.9 | 23.2 | 53.7 | 40.4 | 53.3 | 39.4 |
| 520 | 49.2 | 23.4 | 54.1 | 41.1 | 53.7 | 39.8 |
| 530 | 49.5 | 23.6 | 54.5 | 41.7 | 53.9 | 40.3 |
| 540 | 49.8 | 23.7 | 54.9 | 42.3 | 54.3 | 40.8 |
| 550 | 50.0 | 23.9 | 55.3 | 42.8 | 54.6 | 41.1 |
| 560 | 50.2 | 23.9 | 55.5 | 43.2 | 54.9 | 41.5 |
| 570 | 50.5 | 24.1 | 55.8 | 43.6 | 54.9 | 41.8 |
| 580 | 50.6 | 24.2 | 55.9 | 43.9 | 55.1 | 42.0 |
| 590 | 50.8 | 24.3 | 56.1 | 44.2 | 55.2 | 42.2 |
| 600 | 50.9 | 24.4 | 56.2 | 44.5 | 55.2 | 42.4 |
| 610 | 51.0 | 24.5 | 56.3 | 44.7 | 55.3 | 42.6 |
| 620 | 51.2 | 24.6 | 56.4 | 44.8 | 55.3 | 42.7 |
| 630 | 51.2 | 24.7 | 56.4 | 45.0 | 55.3 | 42.8 |
| 640 | 51.3 | 24.7 | 56.5 | 45.1 | 55.4 | 42.9 |
| 650 | 51.3 | 24.7 | 56.5 | 45.1 | 55.3 | 43.0 |
| 660 | 51.3 | 24.7 | 56.5 | 45.2 | 55.3 | 43.0 |
| 670 | 51.3 | 24.8 | 56.5 | 45.2 | 55.3 | 43.0 |
| 680 | 51.2 | 24.8 | 56.5 | 45.2 | 55.2 | 43.0 |
| 690 | 51.1 | 24.7 | 56.4 | 45.2 | 55.1 | 42.8 |
| 700 | 51.0 | 24.7 | 56.3 | 45.1 | 55.1 | 42.9 |
| 710 | 50.8 | 24.7 | 56.3 | 45.0 | 54.9 | 42.9 |
| 720 | 50.6 | 24.6 | 56.1 | 45.0 | 54.8 | 42.8 |
| 730 | 50.3 | 24.5 | 56.1 | 44.8 | 54.7 | 42.5 |
| 740 | 50.1 | 24.4 | 56.0 | 44.7 | 54.7 | 42.6 |
| 750 | 49.4 | 24.1 | 55.5 | 44.2 | 54.2 | 42.2 |

1. A metallized film comprising:
a polymeric primer layer comprising a first polymer at least a portion of which is cross-linked;
a polymeric protective layer comprising a second polymer at least a portion of which is cross-linked;
a metal layer between the polymeric primer layer and the polymeric protective layer; and
an adhesive layer on the polymeric primer layer opposite the metal layer, the adhesive layer having an outer adhesive surface opposite the polymeric primer layer.

2. A metallized film comprising:
a polymeric primer layer comprising a first polymer at least a portion of which is cross-linked;
a polymeric protective layer comprising a second polymer at least a portion of which is cross-linked; and
a metal layer between the polymeric primer layer and the polymeric protective layer.
said polymeric primer layer comprising a first surface facing the metal layer and said polymeric protective layer comprising a second surface facing the metal layer, wherein at least one of said first and second surfaces comprise a corona discharge surface treatment, a flame surface treatment or a glow discharge surface treatment.

3. The metallized film of claim 1, wherein the polymeric primer layer has an outer adhesive surface opposite the metal layer.

4. The metallized film of claim 2, further comprising an adhesive layer on the polymeric primer layer opposite the metal layer, the adhesive layer having an outer adhesive surface opposite the polymeric primer layer.

5-9. (canceled)

10. The metallized film of claim 1, wherein at least one outermost surface of the metallized film has topographical features thereon.

11. The metallized film of claim 1, wherein both a first surface of the first polymer and a second surface of the second polymer face the metal layer and have: (i) acidic functional groups on the first and second surfaces, or (ii) basic functional groups on the first and second surfaces, or (iii) a corona discharge or glow discharge surface treatment, or (iv) both (i) and (iii), or (v) both (ii) and (iii).

12. (canceled)

13. The metallized film of claim 1, wherein the first and second polymers are substantially cross-linked throughout a thickness of the polymeric primer layer and the polymeric protective layer.

14. The metallized film of claim 1, wherein the polymeric protective layer comprises a cross-linked polyurethane, a cross-linked polymer or copolymer containing carboxyl groups thereon, a cross-linked polyolefin, a cross-linked ethylene/vinyl acetate/acid terpolymer, or any combination thereof; and the polymeric primer layer comprises a cross-linked polyurethane, a cross-linked polymer or copolymer containing carboxyl groups thereon, a cross-linked polyolefin, a cross-linked ethylene/vinyl acetate/acid terpolymer, or any combination thereof.

15-16. (canceled)

17. The metallized film of claim 1, further comprising a substrate adhesively bonded to an outer adhesive surface of the metallized film.

18-19. (canceled)

20. The metallized film of claim 17, wherein the substrate comprises a thermoformable layer.

21-22. (canceled)

23. A thermoformable article comprising the metallized film of any one of claims 1 or 2.

24. A molded part comprising the metallized film or thermoformable article of any one of claims 1 or 2.

25. Signage comprising the metallized film, thermoformable article or molded part of any one of claims 1 or 2.

26. (canceled)

27. A method of forming a metallized film, said method comprising the steps of:
providing a polymeric protective layer having a first surface;
depositing a metal layer over the first surface;
applying a polymeric primer layer over the metal layer so that a second surface of the polymeric primer layer faces the metal layer;
cross-linking the polymeric protective layer;
cross-linking the polymeric primer layer; and
applying an adhesive layer over the polymeric primer layer, the adhesive layer having an outer adhesive surface opposite the polymeric primer layer.

28. A method of forming a metallized film, said method comprising the steps of:
providing a polymeric protective layer having a first surface;
depositing a metal layer over the first surface;
applying a polymeric primer layer over the metal layer so that a second surface of the polymeric primer layer faces the metal layer;
cross-linking the polymeric protective layer;
cross-linking the polymeric primer layer; and
(i) surface treating the first surface prior to said depositing, step, or (ii) surface treating the second surface prior to said applying step, or both (i) and (ii) using a corona discharge surface treatment, a flame surface treatment, or a glow discharge surface treatment.

29. The method of claim 28, wherein the method comprises applying an adhesive layer over the polymeric primer layer.

30. The method of claim 27 or 28, wherein said providing step comprises:
applying a polymeric protective layer composition onto a release substrate; and
removing any water or solvent present in the composition.

31-32. (canceled)

33. The method of claim 27 or 28, further comprising attaching at least one additional layer to an outer surface of the polymeric primer layer opposite the first surface, an outer surface of the protective layer opposite the second surface, an outer surface of the adhesive layer when present, or any combination thereof.

34. (canceled)

35. The method of claim 27 or 28, further comprising providing topographical features to one or both outermost surfaces of the metallized film.

36. (canceled)

37. The method of claim 27 or 28, further comprising attaching a thermoformable layer to an outer adhesive surface of the metallized film to form a thermoformable article.

38. (canceled)

39. The method of claim 27 or 28, further comprising applying graphics to the metallized film.

40. The method of claim 27 or 28, further comprising incorporating the metallized film into signage or backlit signage.
